(19) United States
(12) Patent Application Publication
(10) Pub. No.: US 2024/0304963 A1
(43) Pub. Date: Sep. 12, 2024

(54) BATTERY ASSEMBLY AND METHODS

(71) Applicant: 3M INNOVATIVE PROPERTIES COMPANY, St. Paul, MN (US)

(72) Inventors: Pingfan Wu, Woodbury, MN (US); Jose Maria Benito, Madrid (ES); Stephane Raymond Jacques Blanchot, Feucherolles (FR); Jean Louis Silvestre, Vaux Sur Seine (FR); Junkang Jacob Liu, Woodbury, MN (US); Siwei Leng, Woodbury, MN (US); Maria Jose Sanchez, Madrid (ES); David Bernard Andre Descoins, Belle Eglise (FR)

(21) Appl. No.: 18/269,093

(22) PCT Filed: Dec. 23, 2021
(86) PCT No.: PCT/US2021/065061

§ 371 Date: Jun. 22, 2023

Related U.S. Application Data
(60) Provisional application No. 63/131,126, filed on Dec. 28, 2020.

(51) Int. Cl. H01M 50/588; H01M 50/209; H01M 50/293; H01M 50/505

(52) U.S. Cl. CPC H01M 50/588; H01M 50/209; H01M 50/293; H01M 50/505

(57) ABSTRACT

Provided is a battery assembly that includes a housing, one or more battery cells electrically coupled to a busbar, the one or more battery cells and busbar being received in the housing. A non-woven core layer is disposed between the busbar and housing, the non-woven core layer comprising a plurality of fibers, the plurality of fibers includes a plurality of oxidized polyacrylonitrile fibers and a coating disposed thereon that binds the plurality of oxidized polyacrylonitrile fibers to each other. Advantageously, the provided assemblies can exhibit extremely high electrical resistance, thermal resistance, and very high dielectric breakdown voltage.

### FIELD OF THE INVENTION

Provided are battery assemblies and methods related thereof, including battery assemblies and related methods useful in automotive and aerospace applications.

### BACKGROUND

With the benefits of reduced emissions and fuel cost savings, electric vehicle drivetrains are rapidly displacing traditional internal combustion engines in the transportation sector. As these technologies are developed and scaled up, use of rechargeable batteries to power these drivetrains has greatly expanded, with some battery assemblies containing thousands of individual cells. The evolution of this technology has raised technical challenges around managing risks associated with these high voltage and high current devices in automotive vehicles.

Battery assemblies are generally governed by a battery management system that ensures that a battery is working within a specified nominal range of operating and environmental factors, including charge and discharge currents, cell voltage, and temperature. Common battery systems operate best in a relatively narrow operating range for temperature, generally in the range of from about 15° C. to about 45° C. Outside of this range, the functional safety, service life, and cycle stability of the battery can be compromised. If the temperature exceeds a critical level, thermal runaway occurs. Thermal runaway occurs as a result of a chain reaction in the battery, where temperatures exceeding 700° C. lead to decomposition of battery components, gas formation, and ignition across many cells in the battery.

### SUMMARY

One of the primary causes of thermal runaway is an internal short circuit within the battery assembly. Short circuits can occur as a result of separators within the battery wearing out, or damage to the battery. To avoid this, battery assemblies contain many layers of insulation within the housing of the battery to electrically isolate electrical conductors within the battery from inadvertently contacting each other or the outside casing of the battery assembly, which is commonly made from metal. These materials also help avoid low current leakage which can induce undesirable self-discharge in the battery.

Herein are described nonwoven materials that serve as a flexible electrical and/or thermal insulators, either under the lid, on the bottom, between modules in a battery pack, or even between neighboring cells of the battery pack. Advantageously, these materials can be comprised of abrasion-resistant oxidized polyacrylonitrile (OPAN) fibers that not only have an extremely high electrical resistance but also provide thermal resistance and a dielectric breakdown voltage. As a further advantage, these materials can be made resiliently compressible and conformable to fill complex and irregular enclosures within a battery assembly. Overall, these beneficial properties can enable these materials to mitigate the problem of battery fires.

Notably, while organic materials tend to melt away or shrink into discontinuous pieces at high temperatures (e.g., at 500° C. or 800° C.), webs of oxidized polyacrylonitrile fibers can maintain their entangled structure and keep opposing electrodes separated for an extended period of time.

In a first aspect, a battery assembly is provided. The battery assembly comprises: a housing; one or more battery cells electrically coupled to a busbar, the one or more battery cells and the busbar being received in the housing; and a fibrous core layer disposed between the busbar and the housing, wherein the fibrous core layer comprises a plurality of oxidized polyacrylonitrile fibers and a coating disposed thereon that binds the plurality of oxidized polyacrylonitrile fibers to each other.

In a second aspect, a battery assembly is provided, comprising: an housing; one or more battery cells electrically coupled to a busbar, the one or more battery cells and the busbar being received in the housing; and a fibrous core layer disposed between the busbar and the housing, wherein the fibrous core layer comprises a plurality of oxidized polyacrylonitrile fibers; and a continuous barrier layer extending across one or both major surfaces of the core layer.

In a third aspect, a method of electrically insulating a battery housing from a busbar within a battery assembly is provided, the method comprising: disposing a fibrous core layer on either the busbar or at least a portion of the battery housing; and bringing together the battery housing and the busbar whereby the fibrous core layer is disposed therebetween, wherein the fibrous core layer comprises a plurality of oxidized polyacrylonitrile fibers and a coating disposed thereon that binds the plurality of oxidized polyacrylonitrile fibers to each other.

### BRIEF DESCRIPTION OF THE DRAWINGS

FIGS. 1A and 1B are elevational cross-sectional views of electrically-insulated subassemblies for installation into a battery assembly according to two exemplary embodiments.

FIG. 2-4 are perspective views of battery subassemblies according to various embodiments, with FIGS. 2 and 4 shown in exploded view.

FIG. 5 is an exploded perspective view of a battery assembly according to an exemplary embodiment;

FIG. 6 is a perspective view showing layers of a multi-layered electrical insulator according to another embodiment.

FIG. 7 is an exploded perspective view of a battery subassembly including the multi-layered electrical insulator of FIG. 6.

Repeated use of reference characters in the specification and drawings is intended to represent the same or analogous features or elements of the disclosure. It should be understood that numerous other modifications and embodiments can be devised by those skilled in the art, which fall within the scope and spirit of the principles of the disclosure. The figures may not be drawn to scale.

### Definitions

As used herein:
“ambient conditions” means at 23° C., 101.3 kPa pressure, and 30% relative humidity;
“average” means number average, unless otherwise specified;
“copolymer” refers to polymers made from repeat units of two or more different polymers and includes random, block and star (e.g. dendritic) copolymers;
“non-woven core layer” means a plurality of fibers characterized by entanglement or point bonding of the fibers to form a sheet or mat exhibiting a structure of individual fibers or filaments which are interlaid, but not in an identifiable manner as in a knitted fabric;
“polymer” means a relatively high molecular weight material having a molecular weight of at least 10,000 g/mol;
“size” refers to the longest dimension of a given object or surface;
“substantially” means to a significant degree, as in an amount of at least 30%, 40, 50, 60, 70, 80, 90, 95, 96, 97, 98, 99, 99.5, 99.9, 99.99, or 99.999%, or 100%; and
“thickness” means the distance between opposing sides of a layer or multilayer article.

### DETAILED DESCRIPTION

As used herein, the terms “preferred” and “preferably” refer to embodiments described herein that can afford certain benefits, under certain circumstances. However, other embodiments may also be preferred, under the same or other circumstances. Furthermore, the recitation of one or more preferred embodiments does not imply that other embodiments are not useful, and is not intended to exclude other embodiments from the scope of the invention.

As used herein and in the appended claims, the singular forms “a,” “an,” and “the” include plural referents unless the context clearly dictates otherwise. Thus, for example, reference to “a” or “the” component may include one or more of the components and equivalents thereof known to those skilled in the art. Further, the term “and/or” means one or all of the listed elements or a combination of any two or more of the listed elements.

It is noted that the term “comprises” and variations thereof do not have a limiting meaning where these terms appear in the accompanying description. Moreover, “a,” “an,” “the,” “at least one,” and “one or more” are used interchangeably herein. Relative terms such as left, right, forward, rearward, top, bottom, side, upper, lower, horizontal, vertical, and the like may be used herein and, if so, are from the perspective observed in the particular drawing. These terms are used only to simplify the description, however, and not to limit the scope of the invention in any way.

Reference throughout this specification to “one embodiment,” “certain embodiments,” “one or more embodiments” or “an embodiment” means that a particular feature, structure, material, or characteristic described in connection with the embodiment is included in at least one embodiment of the invention. Thus, the appearances of the phrases such as “in one or more embodiments,” “in certain embodiments,” “in one embodiment” or “in an embodiment” in various places throughout this specification are not necessarily referring to the same embodiment of the invention. Where applicable, trade designations are set out in all uppercase letters.

### Battery Assemblies

Described herein are various battery assemblies. These assemblies include battery packs, which can in turn include one or more battery modules. Alternatively, within a battery pack, surrounding support structure can allow for multiple battery cells to be installed directly in the chassis of a vehicle (or other target application) without need for battery modules. A housing is generally required to protect the individual battery cells and/or modules.

Various types of battery cells exist, including cylindrical, prismatic, and pouch cells. Pouch cells can have a maximum excursion temperature at 500° C., while some high-density designs have a maximum excursion temperature of 800° C. Excursion temperature is defined as a temperature that may be encountered in an adverse situation but only sustained over a relatively short period of time, such as when thermal runaway occurs.

For battery safety or thermal runaway protection, useful materials can maintain thermal, electrical and mechanical insulation performance at a given maximum temperature (e.g., 500° C.) during an excursion period (e.g., 5 minutes). Such material requirements can include:
Thermal insulation: While one major surface of the insulation is heated from ambient temperature to a maximum temperature (e.g., 500° C. or 800° C.), the temperature of the opposing major surface should be maintained at or below a certain value (e.g., 400° C., 390, 380, 370, 360, 350, 340, 330, 320, 310, 300, 290, 280, 270, 260° C. or 250° C.) over a specified time frame (e.g., 5 minutes);
Electrical insulation: No electrical breakdown occurs at the maximum temperature (e.g., breakdown voltage is maintained higher than 1 kV); and
Mechanical separation: In the event thermal runaway occurs, during an excursion period (5 minutes) the insulation material can maintain the gap between two metal electrodes or metal plates such that electrical breakdown is avoided and/or thermal transmission is significantly reduced.

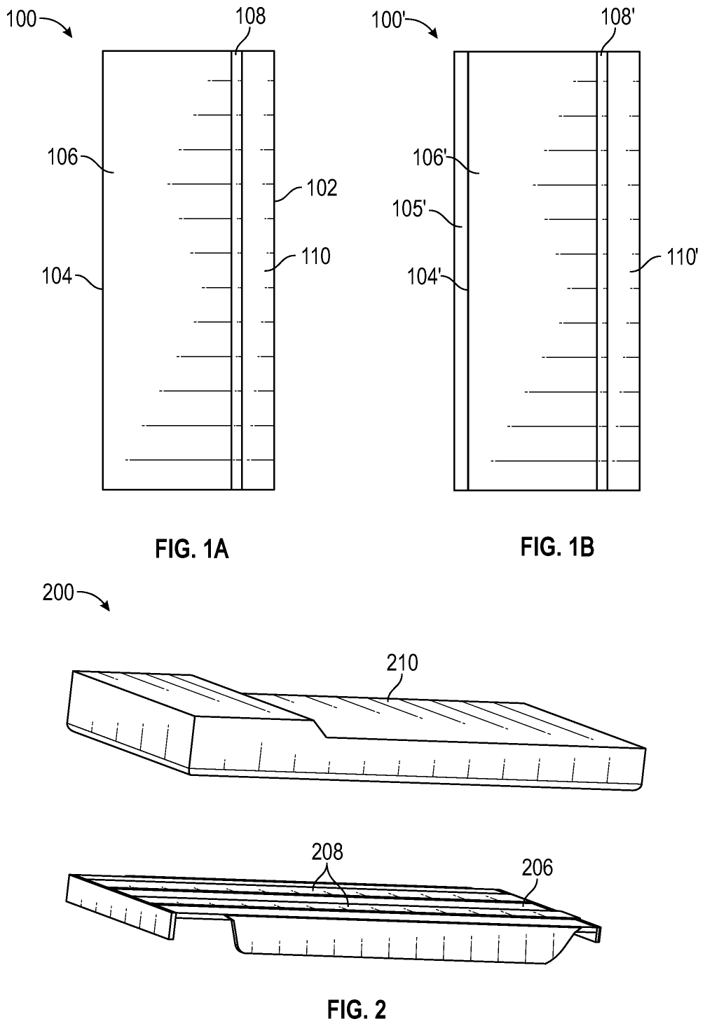

A generalized subassembly containing such a material for incorporation into a battery assembly is shown in FIG. 1A and referred to by the numeral 100 herein. As shown, the subassembly 100 has a multi-layered construction with an outward-facing major surface 102 and inward-facing major surface 104. The layers of the subassembly 100 include a non-woven core layer 106 exposed at the inward-facing major surface 104, an adhesive layer 108, and an electrically-conductive plate 110 that is exposed at the outward-facing major surface 102.

Optionally and as shown, the non-woven core layer 106, adhesive layer 108, and plate 110 directly contact each other as shown in FIG. 1A. Alternatively, one or more additional layers, such as primers, tie layers, scrims, or other functional layers, may be disposed between adjacent layers of the subassembly 100 or on either major surface 102, 104 of the subassembly or any of its constituent layers. While the subassembly 100 is shown having a generally rectilinear shape in this figure, it is to be understood that it could include bends and/or curved contours based on the shape of the battery assembly.

The non-woven core layer 106 is an electrical insulator. Preferably, the non-woven core layer 106 is made from a carbonized and/or other non-meltable fiber and displays an electrical resistivity of at least 0.1 G-ohm meters, at least 1 G-ohm meters, at least 10 G-ohm meters, or in some embodiments, less than, equal to, or greater than 0.1 G-ohm meters, 1, 10, 100, or 1000 G-ohm meters. In various embodiments, the non-woven core layer 106 can incorporate reinforcing fibers and/or binders, as will be described later.

Another advantageous feature relates to the dielectric strength of the non-woven core layer 106, representing its ability to prevent the flow of an electrical current under an applied electrical stress. Dielectric strength is expressed in voltage per unit thickness, such as in kV/mm. Measurement can be conducted using a standard method such as ASTM D-149-20.

Unlike many other materials found in electrical insulation applications, this layer can provide a dielectric strength of at least 0.1 kV/mm, 0.2, 0.3, 0.4, 0.5, 0.6, 0.7, 0.8, 0.9, or at least 1.0 kV/mm at ambient conditions, even after being subjected to a temperature of at least 500° C. for 5 minutes. Irrespective of thickness, the non-woven core layer 106 preferably has a breakdown voltage of at least 1 kV, 2, 3, 4, 5, 6, 7, 8, 9, or 10 kV at ambient conditions after being subjected to a temperature of at least 500° C. for 5 minutes.

The intrinsic properties of the non-woven core layer 106 enable the overall subassembly 100 in FIG. 1A to have both a high dielectric strength and thus high breakdown voltage. Further, these properties provide for a high electrical resistance measured between the outward-facing and inward-facing major surfaces 102, 104 (e.g., along a direction perpendicular to the major surfaces 102, 104). Particularly useful carbonized fibers include oxidized polyacrylonitrile (OPAN) fibers. Details relating to the non-woven core layer, reinforcing fibers, and scrims are described in respective subsections below.

The adhesive layer 108 need not be particularly limited but preferably has flame-retardant properties. Suitable adhesives can include heat-activated adhesives containing polyurethanes or acrylates. In some embodiments, the adhesive is stimuli-responsive. For example, the adhesive layer 108 can be initially non-tacky, enabling it to be stored unprotected by a release liner, but become tacky upon activation by heat. Exemplary materials are described in Y. L. Dar, W. Yuan-Huffman, S. Shah, and A. Xiao, J. Adhesion Sci. Technol., 21, 1645 (2007). Adhesive compositions can also be blended with flame retardant agents such as bromine, phosphate, and iodine salts. Optionally, the adhesive is a pressure-sensitive adhesive.

The plate 110 can be, in some embodiments, part of a battery assembly housing. The plate 110 is commonly made from a rigid, metallic material, such as a nickel-plated steel, stainless steel, or aluminum. The purpose of the plate 110 is to provide mechanical strength to the battery subassembly 100 and help prevent punctures or leakage in the event the battery assembly is damaged in a collision or other external factor.

FIG. 1B shows a subassembly 100′ having most of the same features as subassembly 100 but further including a technical enhancement that can be useful in certain applications. Like the previous embodiment, the subassembly 100′ includes a non-woven core layer 106′ bonded to a plate 110′ by an adhesive layer 108′. In this instance, however, a barrier layer 105′ is disposed on the inward-facing major surface 104′ of the non-woven core layer 106′. Optionally and as shown the barrier layer 105′ directly and continuously contacts the non-woven core layer 106′. While not shown, it is understood that the barrier layer 105′ can be disposed, alternatively or in combination, on the outward-facing major surface of the non-woven core layer 106′.

The barrier layer 105′ is preferably an impermeable layer and can be a solid (non-porous) layer. As an impermeable layer, barrier layer 105′ can advantageously prevent gases and conductive particles from penetrating through the subassembly 100′ in the event of a battery fire. In some embodiments, the barrier layer 105′ is made from a fire-resistant polymer such as a polyimide. In an alternative embodiment, the barrier layer 105′ is made from an inorganic filler that is dispersed into a suitable binder. Inorganic materials useful for this purpose can include halloysite, inclusive of halloysite nanotubes (HNT), vermiculite, mica, and combinations thereof. At least some of these inorganic fillers may be expandable when heated.

A significant technical benefit of using vermiculite, mica, and other platelet-shaped filler particles in the barrier layer 105′ is the tendency for these particles to localize at the surface of the non-woven core layer 106′ to form a discrete surface layer, as shown in FIG. 1B. These particles, by virtue of their aspect ratio, align generally parallel to the inward-facing major surface 104′ of the non-woven core layer 106′ and are sufficiently large that they do not penetrate into the non-woven core layer 106′. Parallel alignment of these particles can substantially improve the overall barrier properties of the barrier layer 105′. The inorganic filler can be present in an amount from 1 percent to 80 percent, from 5 percent to 65 percent, from 10 percent to 50 percent, or in some embodiments, less than, equal to, or greater than 1 percent, 2, 3, 4, 5, 7, 10, 12, 15, 17, 20, 25, 30, 35, 40, 45, 50, 55, 60, 65, 70, 75, or 80 percent, relative to the overall weight of the barrier layer 105′.

A significant technical benefit of using halloysite in the barrier layer 105′ is the hollow structure and specific properties of this mineral. It is a material with low thermal conductivity (insulator). At high temperatures, these nanotubes can release water absorbed at 400° C., an endothermic process that can reduce the temperature around the fibers and dilute oxygen and other combustible gases to increase temperature resistance of the barrier layer 105′. The released water above 400° C. may further quench the fire improving its flame retardancy.

At very high temperature>800° C. HNTs can be degraded in an endothermic process, helping to reduce the temperature and forming char to protect fibers. A network of high aspect ratio particles at flame-fiber interface can provide a “gel”-like structure and along with the exposed acidic surface hydroxyl groups could aid in char formation. Further, its hollow structure can help to capture free radicals in the lumen of the nanotubes.

Binders for the inorganic fillers are not particularly restricted, and can include any of the binder compositions described in the forthcoming subsection entitled “Binders.” In a preferred embodiment, a silicone binder is used. Silicones primarily decompose into silica (SiO₂) and carbon oxides at high temperatures. As a combustion product, silica can help maintain the mechanical integrity of the barrier layer 105′ even when subjected to temperatures hot enough to burn the silicone, which can exceed 450° C. While inorganic fillers such as vermiculite and mica may be sized to localize at the surface of the non-woven core layer 106′, the liquid silicone binder can penetrate in the fibrous structure of the non-woven core layer 106′ to some degree. Interpenetration of the binder into the fibrous structure can help the barrier layer 105′ adhere to the non-woven core layer 106′.

The thickness of the barrier layer 105′ is not prescribed but should be sufficient to satisfy its barrier requirements without unduly compromising the overall flexibility and resiliency of the non-woven core layer 106′ required for the application. Useful thicknesses can be from 50 micrometers to 25000 micrometers, from 200 micrometers to 10000 micrometers, from 500 micrometers to 2000 micrometers, or in some embodiments, less than, equal to, or greater than 50 micrometers, 60, 70, 80, 90, 100, 110, 120, 150, 170, 200, 250, 300, 350, 400, 450, 500, 600, 700, 800, 900, 1000, 2000, 5000, 7000, 10000, 15000, 20000, or 25000 micrometers.

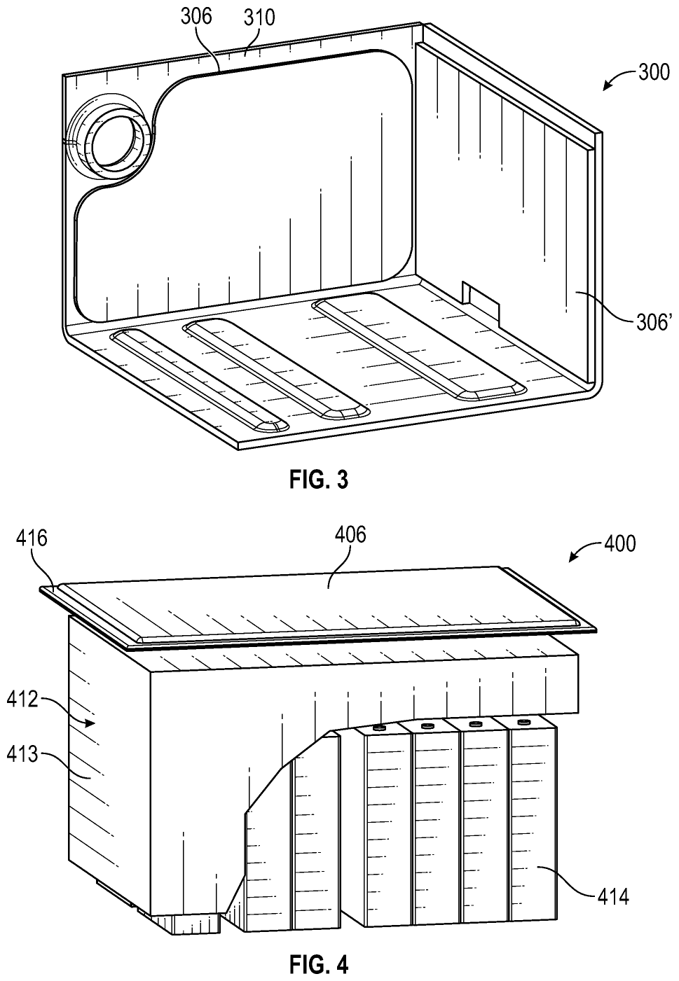

FIG. 2 shows a subassembly 200 formed into a more complex configuration. Here, the subassembly 200 includes a lid 210 having five orthogonal walls as shown that collectively define a bottom-facing cavity (not visible in FIG. 2). Assuming a shape that conforms with the cavity is a non-woven core layer 206 and two elongated strips of adhesive layer 108. The strips of adhesive layer 108 bond the non-woven core layer 206 and the lid 210 to each other.

FIG. 3 shows a subassembly 300 according to an alternative configuration, in which a plate 310 includes three orthogonal walls and two distinct non-woven core layers 306, 306′ are coupled to the walls of the plate 310. In this embodiment, the non-woven core layers 306, 306′ can be adhesively bonded to the plate 310 or attached using mechanical joints, such as using one or more clips, hooks, fasteners, or even just an interference fit provided by neighboring subassembly structures. Optionally, one or more openings could be present in the non-woven core layer 306 to accommodate a mechanical joint to be disposed on the plate 110.

FIG. 4 is a fragmentary view showing a battery subassembly 400 within a battery assembly including a battery module 412 that includes a housing 413 that at least partially encloses a plurality of individual cells 414. In some instances, the housing 413 is metallic and can be electrically-conductive. The materials used to construct the housing 413 need not be limited, and can include aluminum, steel, or a polymer composite, depending on performance and weight requirements.

Located above the battery module 412 is a non-woven core layer 406 having a sealed peripheral edge 416 and bonded to the housing 413 by an interposing adhesive layer (not visible in the figure). Advantageously, edge sealing of the peripheral edge 416 allows internal fibers within the non-woven core layer 406 to be substantially encapsulated, preventing the fibers from shedding or otherwise being dislodged during operation of the battery. Edge sealing can also help prevent or mitigate the degree of shrinkage when the non-woven core layer 406 is exposed to very high temperatures. As described in a later section, binders can be incorporated into the non-woven core layer to assist in making edge sealed configurations such as shown in FIG. 4. The depicted configuration can help reduce or eliminate current leakage from the battery module 412 during long-term use or storage.

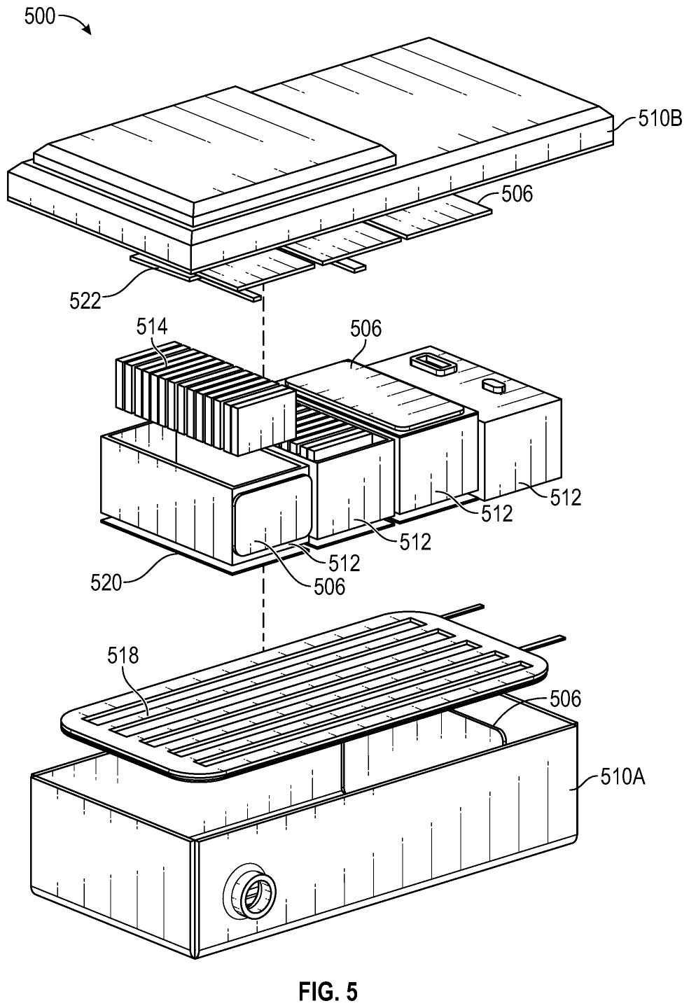

FIG. 5 shows a comprehensive battery assembly 500 in which the aforementioned electrically-insulating layered structures can be advantageously deployed. The assembly 500, shown in exploded view, incorporates components bearing many structural similarities to the battery subassemblies 100, 200, 300, 400 previously shown and described. In FIG. 5, the battery assembly 500 includes a housing collectively provided by mating components battery case 510A and battery lid 510B. Received therein are battery modules 512, each containing a plurality of individual battery cells 514 similar to those shown previously in FIG. 4. In the embodiment shown, four battery modules 512 are shown, although this number is merely exemplary.

Residing on the inner bottom surface of the case 510A beneath the battery modules 512 is a cooling plate 518, which is typically made from a highly thermally-conductive metal such as steel or aluminum, and a conformable thermal pad 520 to conduct heat from the battery modules 512 to the cooling plate 518.

Extending along the top surfaces of the battery modules 512 is a busbar 522, a strip of metal that is electrically coupled to one or more battery modules 512 within the battery assembly 500. The busbar 522 conducts an electric current and provides power distribution within the battery assembly 500. In exemplary embodiments, the busbar 522 itself is not electrically insulated. Throughout the battery assembly 500 in the space enclosed by the case 510A and lid 510B are electrically-insulating layers 506, each including at least one non-woven core layer and optionally an adhesive layer disposed thereon, as used in the subassembly 100 of FIG. 1A.

Referring again to FIG. 5, the non-woven core layer is disposed between the busbar 522 and housing to electrically insulate these components from each other. Generally, electrical insulation of the busbar from housing components can be generally achieved by disposing the non-woven core layer on either the busbar or housing component and then bringing together the busbar and housing component such that the non-woven core layer is disposed between them.

Although not explicitly shown here, it is further contemplated that the battery cells 514 might not be consolidated into battery modules 512. In such an embodiment, the battery cells 514 could be directly installed within the housing provided by the battery case 510A and battery lid 510B.

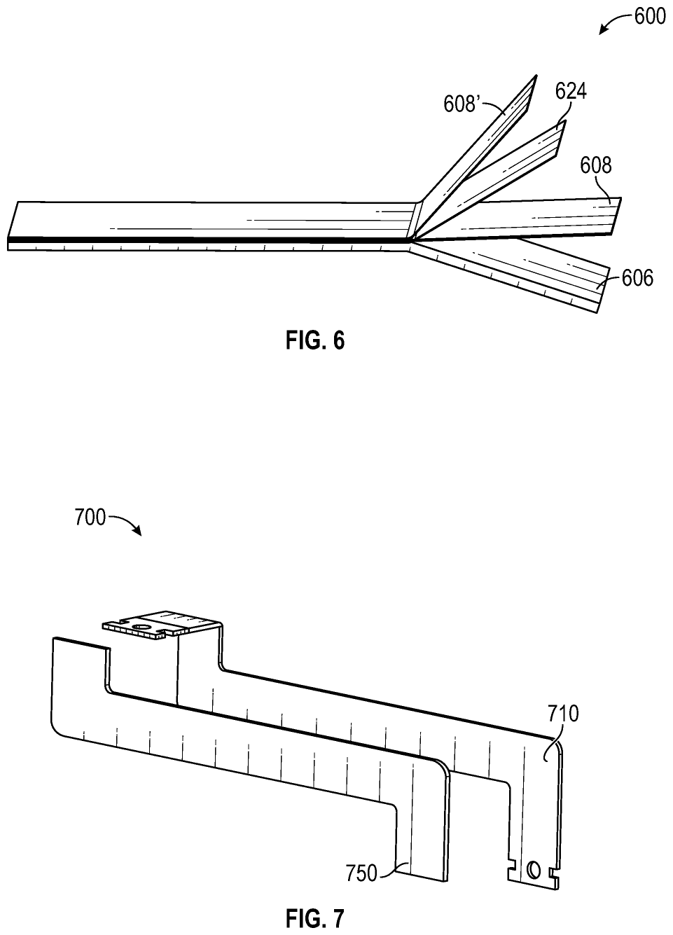

FIG. 6 shows a multi-layered electrically insulating article 600 that can be adhesively bonded to a busbar or other electrically active surface within a battery assembly. The bottom major surface of the article 600 is comprised of a non-woven core layer 606, with a first adhesive layer 608 extending across and directly contacting the non-woven core layer 606. Both are analogous to those layers of subassembly 100. A backing 624 extends across and directly contacts the first adhesive layer 608, and a second adhesive layer 608′ extends across and directly contacts the backing 624.

The backing 624 enhances the structural integrity of the article 600 and can facilitate handling by providing a non-friable layer that bonds strongly to the adhesive 608′. Advantageously, the article 600 can be transported and stored on a release liner (not shown in FIG. 6), from which it is released prior to use by gripping the backing 624 and peeling the article 600 away from the release liner. In this manner, the backing 624 can prevent delamination between the non-woven core layer 606 and the first adhesive layer 608 upon liner release that would occur if the non-woven core layer 606 and first adhesive layer 608 was directly bonded to the liner. The backing 624 can also be made from various useful electrically-insulating materials, including but not limited to, polyester, polyimide, and polyvinyl chloride.

FIG. 7 shows a busbar assembly 700 where a busbar 710 extends along three dimensions. An electrically-insulating article 750 having a shape generally matching that of the busbar 710 extends across a major surface of the busbar 710 to provide protection against shorting or current leakage along these overlapping regions. In a preferred embodiment, the electrically-insulating article 750 has a multi-layered structure such as shown in the electrically insulating article 600 of FIG. 6, and can be formed into a customized shape by a die cutting process.

Optionally, the article 750 can be ultrasonically welded to itself and/or wrapped around the busbar 710 without use of an adhesive.

### Non-Woven Core Layers

The non-woven core layer is preferably comprised of a plurality of OPAN fibers. The OPAN fibers can include, for example, those available under the trade designations PYRON (Zoltek Corporation, Bridgeton, MO) and PANOX (SGL Group, Meitingen, Germany). In a preferred embodiment, the OPAN fibers are randomly oriented within the non-woven core layer.

The OPAN fibers derive from precursor fibers containing a copolymer of acrylonitrile and one or more co-monomers. Useful co-monomers include, for example, methyl methacrylate, methyl acrylate, vinyl acetate, and vinyl chloride. The co-monomer(s) may be present in an amount of up to 15 wt %, 14 wt %, 13 wt %, 12 wt %, 11 wt %, 10 wt %, 9 wt %, or 8 wt %, relative to the overall weight of the monomer mixture prior to copolymerization.

Oxidation of the precursor fibers can be achieved by first stabilizing the precursor fibers at high temperatures to prevent melting or fusion of the fibers, carbonizing the stabilized fibers to eliminate the non-carbon elements and finally a graphitizing treatment at even higher temperatures to enhance the mechanical properties of the non-woven fibers. OPAN fibers, as referred to herein, include polyacrylonitrile fibers that are either partially or fully oxidized.

In some embodiments, the OPAN fibers are stabilized. Stabilization can be carried out by controlled heating of the precursor fiber in air or some other oxidizing atmosphere. Oxidation typically takes place at temperatures in the range of from 180° C. to 300° C., with a heating rate of from 1-2° C. per minute.

If desired, the precursor fibers can undergo further processing to reduce shrinkage. Shrinkage of the precursor fibers can be reduced by stretching the fibers along their axis during the low-temperature stabilization treatment. Such stretching can produce OPAN fibers with a high degree of preferred orientation along the fiber axis. The stabilization process produces changes in chemical structure of the acrylic precursor whereby the material becomes thermally stable to subsequent high temperature treatments. During this process, the fibers change in color to black. The black fibers are carbonized in an inert atmosphere at high temperatures, typically from 1000° C. to 1500° C., at a slow heating rate to avoid damage to the molecular order of the fiber. The fibers are given a graphitizing treatment at high temperatures for example, above 2000° C. to 3000° C. to improve the texture of the fiber and to enhance the tensile modulus of the non-woven core layer. If desired, the strength and the tensile modulus of the fibers can be further improved by stretching at elevated temperatures. With this treatment, the non-woven core layer can display a tensile strength of at least 28 kPa, as measured along any and all transverse directions.

The fibers used in the non-woven core layer can have a fiber diameter and length that enables the fibers to become entangled within the non-woven core layer. The fibers, however, are preferably not so thin that web strength is unduly compromised. The fibers can have a median fiber diameter of from 1 micrometers to 100 micrometers, from 2 micrometers to 50 micrometers, from 5 micrometers to 20 micrometers, or in some embodiments, less than, equal to, or greater than 1 micrometer, 2, 3, 5, 7, 10, 15, 20, 25, 30, 40, 50, 60, 70, 80, 90, or 100 micrometers.

Inclusion of long fibers can reduce fiber shedding and further enhance strength of the non-woven core layer along transverse directions. The fibers of the non-woven core layer can have a median fiber length of from 10 millimeters to 100 millimeters, from 15 millimeters to 100 millimeters, from 25 millimeters to 75 millimeters, or in some embodiments, less than, equal to, or greater than 10 millimeters, 12, 15, 17, 20, 25, 30, 35, 40, 45, 50, 55, 60, 65, 70, or 75 millimeters.

The OPAN fibers used to form the non-woven core layer can be prepared from bulk fibers. The bulk fibers can be placed on the inlet conveyor belt of an opening/mixing machine in which they can be teased apart and mixed by rotating combs. The fibers are then blown into web-forming equipment where they are formed into a dry-laid non-woven core layer.

As an alternative, a SPIKE air-laying forming apparatus (commercially available from FormFiber NV, Denmark) can be used to prepare nonwoven fibrous webs containing these bulk fibers. Details of the SPIKE apparatus and methods of using the SPIKE apparatus in forming air-laid webs are described in U.S. Pat. No. 7,491,354 (Andersen) and U.S. Pat. No. 6,808,664 (Falk et al.).

Bulk fibers can be fed into a split pre-opening and blending chamber with two rotating spike rollers with a conveyor belt. Thereafter, the bulk fibers are fed into the top of the forming chamber with a blower. The fibrous materials can be opened and fluffed in the top of the chamber and then fell through the upper rows of spikes rollers to the bottom of the forming chamber passing thereby the lower rows of spike rollers. The materials can then be pulled down on a porous endless belt/wire by a combination of gravity and vacuum applied to the forming chamber from the lower end of the porous forming belt/wire.

Alternatively, the non-woven core layer can be formed in an air-laid machine. The web-forming equipment may, for example, be a RANDO-WEBBER device commercially-available from Rando Machine Co., Macedon, NY. Alternatively, the web-forming equipment could be one that produces a dry-laid web by carding and cross-lapping, rather than by air-laying. The cross-lapping can be horizontal (for example, using a PROFILE SERIES cross-lapper commercially-available from ASSELIN-THIBEAU of Elbeuf sur Seine, 76504 France) or vertical (for example, using the STRUTO system from the University of Liberec, Czech Republic or the WAVE-MAKER system from Santex AG of Switzerland).

The OPAN fibers can be present in any amount sufficient to provide the desired electrically insulation properties, as well as flame resistance and thermal insulating properties, if also desired.

The OPAN fibers can be present in an amount of from 60 wt % to 100 wt %, 70 wt % to 100 wt %, 81 wt % to 100 wt %, or in some embodiments, less than, equal to, or greater than 50 wt %, 55, 60, 65, 70, 75, 80, 85, 90, or 95 wt %, or less than or equal to 100 wt %.

In some embodiments, the non-woven core layer includes a multiplicity of fiber entanglements, where two or more discrete fibers become knotted or twisted together. The fibers within these entanglements, while not physically attached, can be so intertwined that they resist separation when pulled in opposite directions.

Entanglements can be induced by a needle tacking process or hydroentangling process. Advantageously, these processes can provide entanglements in which the fibers in the non-woven core layer are substantially entangled along directions perpendicular to the major surfaces of the non-woven core layer, thereby enhancing loft and increasing strength of the non-woven core layer along these directions.

The non-woven core layer can be entangled using a needle tacker commercially available under the trade designation DILO from Dilo Machines GmbH, Germany, with barbed needles (commercially available, for example, from Foster Needle Company, Inc., Manitowoc, WI) whereby the substantially entangled fibers described above are needle tacked fibers. Needle tacking, also referred to as needle punching, entangles the fibers perpendicular to the major surface of the non-woven core layer by repeatedly passing an array of barbed needles through the web and retracting them while pulling along fibers of the web.

The needle tacking process parameters, which include the type (or types) of needles used, penetration depth, and stroke speed, are not particularly restricted. Further, the optimum number of needle tacks per area of mat will vary depending on the application. Typically, the non-woven core layer is needle tacked to provide an average of at least 5 needle tacks/cm². Preferably, the mat is needle tacked to provide an average of about 5 to 60 needle tacks/cm², more preferably, an average of about 10 to about 20 needle tacks/cm².

Further options and advantages associated with needle tacking are described elsewhere, for example in U.S. Patent Publication Nos. 2006/0141918 (Rienke), 2011/0111163 (Bozouklian et al.), and International Patent Publication No. WO2019090659 (Cai et al.).

As a further option, the non-woven core layer can be hydroentangled using a conventional water entangling unit (commercially available from Honeycomb Systems Inc. of Bidderford, Maine.; also see U.S. Pat. No. 4,880,168 (Randall, Jr.)). Although the preferred liquid to use with the hydroentangler is water, other suitable liquids may be used with or in place of the water.

In a water entanglement process, a pressurized liquid such as water is delivered in a curtain-like array onto a non-woven core layer, which passes beneath the liquid streams. The mat or web is supported by a wire screen, which acts as a conveyor belt. The mat feeds into the entangling unit on the wire screen conveyor beneath the jet orifices. The wire screen is selected depending upon the final desired appearance of the entangled mat. A coarse screen can produce a mat having perforations corresponding to the holes in the screen, while a very fine screen (e.g., 100 mesh) can produce a mat without the noticeable perforations.

In exemplary embodiments, the non-woven core layer has an average bulk density of from 15 kg/m³ to 300 kg/m³, 15 kg/m³ to 200 kg/m³, 15 kg/m³ to 50 kg/m³, or in some embodiments less than, equal to, or greater than 15 kg/m³, 20, 25, 30, 35, 40, 45, 50 kg/m³. Useful basis weights (in grams per square meter, or “gsm”) for the non-woven core layer can be from 15 gsm to 500 gsm, from 30 gsm to 300 gsm, from 30 gsm to 140 gsm, or in some embodiments, less than, equal to, or greater than 15 gsm, 20, 25, 30, 35, 40, 45, 50, 60, 70, 80, 90, 100, 110, 120, 130, 140, 150, 170, 200, 250, 300, 350, 400, 450, or 500 gsm.

The provided non-woven core layers are capable of being both highly compressible and highly conformable. This property can confer a significant versatility in battery insulation applications, because the spacing between the metallic battery housing and busbars often follows complex, three-dimensional contours and is generally non-uniform. Since the non-woven core layer is highly flexible, it can be wrapped around curved battery modules and fit into enclosures that have varying shapes and sizes without buckling or wrinkling like film or paper insulators. The resilient nature of the core layer allows it to compressibly conform to curved surfaces along the housing and busbar components. In some cases, the non-woven core layer can expand into spaces within the battery assembly, and help restrict movement of neighboring components.

In a preferred embodiment, the non-woven core layer recovers to at least 70% of its original thickness 5 minutes after being compressed to 37% of its original thickness at ambient conditions.

### Reinforcing Fibers

In some embodiments, the non-woven core layer includes a plurality of OPAN fibers blended with a plurality of secondary fibers known as reinforcing fibers. The reinforcing fibers may include binder fibers, which have a sufficiently low melting temperature to allow subsequent melt processing of the non-woven core layer. Binder fibers are generally polymeric, and may have uniform composition or contain two or more components. In some embodiments, the binder fibers are bi-component fibers comprised of a core polymer that extends along the axis of the fibers and is surrounded by a cylindrical shell polymer. The shell polymer can have a melting temperature greater than or less than that of the core polymer.

As used herein, however, “melting” refers to a gradual transformation of the fibers or, in the case of a bi-component shell/core fiber, an outer surface of the fiber, at elevated temperatures at which the polymer (e.g., polyester) shell component becomes sufficiently soft and tacky to bond to other fibers with which it comes into contact, including OPAN fibers and other binder fibers that may have a higher or lower melting temperature as described above.

Certain thermoplastic materials such as polyester can become tacky when melted, making them suitable materials for the outer surface of a binder fiber. Useful binder fibers have outer surfaces comprised of a polymer having a melting temperature of from 100° C. to 300° C., or in some embodiments, less than, equal to, or greater than, 100° C., 105, 110, 115, 120, 125, 130, 135, 140, 145, 150, 160, 170, 180, 190, 200, 210, 220, 230, 240, 250, 260, 270, 280, 290, or 300° C.

Binder fibers increase structural integrity in the non-woven core layer by creating a three-dimensional array of nodes where constituent fibers are physically attached to each other. These nodes provide a macroscopic fiber network, which increases tear strength, tensile modulus, preserves dimensional stability of the end product, and reduces fiber shedding. Advantageously, incorporation of binder fibers can allow bulk density to be reduced while preserving structural integrity of the non-woven core layer, which in turn decreases both weight and thermal conductivity.

The reinforcing fibers can have any suitable diameter to impart sufficient loft, compressibility, and tear resistance to the non-woven core layer. The reinforcing fibers can have a median fiber diameter of from 10 micrometers to 1000 micrometers, 15 micrometers to 300 micrometers, 20 micrometers to 100 micrometers, or in some embodiments, less than, equal to, or greater than 10 micrometers, 15, 20, 25, 30, 35, 40, 45, 50, 60, 70, 80, 90, 100, 120, 150, 170, 200, 250, 300, 400, 500, 750, or 1000 micrometers.

The reinforcing fibers can be present in an amount of from 1 wt % to 40 wt %, 3 wt % to 30 wt %, 3 wt % to 19 wt %, or in some embodiments, equal to or greater than 0 wt %, or less than, equal to, or greater than 1 wt %, 2, 3, 4, 5, 7, 10, 15, 20, 25, 30, 35, 40, 45, or 50 wt %, relative to the overall weight of the non-woven core layer.

Preferred weight ratios of the OPAN fibers to reinforcing fibers bestow both high tensile strength to tear resistance to the non-woven core layer as well as acceptable flame retardancy—for instance, the ability to pass the UL-94V0 flame test. The weight ratio of OPAN fibers to reinforcing fibers can be at least 4:1, at least 5:1, at least 10:1, or in some embodiments, less than, equal to, or greater than 4:1, 5:1, 6:1, 7:1, 8:1, 9:1, or 10:1.

The non-woven core layers described herein can achieve surprisingly low thermal conductivity coefficients. For example, the non-woven core layer of the provided non-woven core layers can display a thermal conductivity coefficient of less than 0.035 W/K-m, less than 0.033 W/m-K, less than 0.032 W/m-K, or in some embodiments, less than, equal to, or greater than 0.031 W/m-K, 0.032, 0.033, 0.034, or 0.035 W/m-K, at ambient conditions according to ASTM D1518-85 (re-approved 2003). Thermal conductivity coefficients in these ranges can be obtained with the non-woven core layer in its relaxed configuration (i.e., uncompressed) or compressed to 20% of its original thickness based on ASTM D5736-95 (re-approved 2001).

As a further option, it is possible that the non-woven core layer includes a plurality of fibers that are neither OPAN fibers nor reinforcing fibers having an outer surface comprised of a polymer with a melting temperature of from 100° C. to 300° C. Such fibers may include, for example, polyester fibers having a melting temperature exceeding 300° C. To maximize the flame retardancy of the non-woven core layer, however, it is preferred that the OPAN fibers represent over 80 vol %, over 85 vol %, over 90 vol %, or over 95 vol % of the fibers in the core layer.

The reinforcing fibers can differ from the plurality of oxidized polyacrylonitrile fibers not only in composition and fiber diameter, but also degree of oxidation where oxidized polyacrylonitrile fibers are used as reinforcing fibers. Differences in the degree of oxidation can be manifest, for example, when dealing with OPAN fibers having a significant distribution of sizes. Where there is a multimodal distribution of OPAN fiber diameter, the smaller diameter fibers tend to have a higher degree of oxidation than the larger diameter fibers. A lower degree of oxidation, in turn, can promote greater fiber resiliency and toughness. For a single fiber, the degree of oxidation can vary between the shell and the core of the fiber, with the outer surface of the fiber being more oxidized than the core.

Optionally, one or both of the OPAN fibers and reinforcing fibers are crimped to provide a crimped configuration (e.g., a zigzag, sinusoidal, or helical shape). Alternatively, some or all of the OPAN fibers and reinforcing fibers have a linear configuration. The fraction of OPAN fibers and/or reinforcing fibers that are crimped can be less than, equal to, or greater than 5%, 10, 15, 20, 25, 30, 40, 50, 60, 70, 80, 90, or 100%. Crimping, which is described in more detail in European Patent No. 0 714 248, can significantly increase the bulk, or volume per unit weight, of the non-woven core layer.

### Binders

The non-woven core layer optionally includes a binder to enable edge sealing of the electrical insulator. The binder can be disposed on the optional scrims and/or the non-woven core layer. The presence of the binder allows the peripheral edge of the optional scrim(s) to be edge sealed by melting at least part of the binder.

The binder can take many forms. In some embodiments, the binder is provided through inclusion of binder fibers as described above. Useful binder fibers can include bicomponent fibers, including melty fibers, or monocomponent fibers. As an example, a suitable bicomponent fiber could include a polyester or nylon core with a low melting polyolefin sheath. As a further example, the bicomponent fiber could have a polyester core with a polyester-polyolefin copolymer sheath, such as provided under the trade designation CELBOND by KoSa, Houston, TX. This fiber has a sheath component with a melting temperature of approximately 230° F. (110° C.). The binder fibers can also be a polyester homopolymer or copolymer rather than a bi-component fiber.

Suitable monocomponent fibers include thermoplastic fibers with softening temperature less than 150° C., such as fibers of polyolefin or nylon. Other suitable monocomponent fibers include thermoplastic fibers with softening temperature less than 260° C. (such as certain polyester fibers). For enhanced loft, it is beneficial for these binder fibers to be crimped, as mentioned above with respect to the reinforcing fibers.

Optionally, these binder fibers can also function as reinforcing fibers for the non-woven core layer. Alternatively, the binder fibers may be blended into the non-woven core layer as a separate component from the reinforcing fibers described in the previous section.

In other embodiments, the binder is provided by a coating. Advantageously, such a coating can act to bind the fibers of the non-woven core layer to each other and bestow the non-woven core layer with significantly improved abrasion resistance. The coating can be disposed on the optional scrims, the non-woven core layer, or both. The coating can be applied using any known method, such as solution casting or hot melt coating. Useful solution casting methods including brush, bar, roll, wiping, curtain, rotogravure, spray, or dip coating techniques.

Coatings effective in edge sealing the non-woven core layer include latices made from vinyl acrylate such as polyvinylchloride acrylate, acrylic, and polyurethane polymers. Exemplary coatings can be provided by acrylic latex emulsions sold under the trade designation VYCAR by Lubrizol Corporation, Wickliffe, OH and acrylic/vinyl acetate copolymers sold under the trade designation POLYCO and polyurethane-based latices sold under the trade designations RHOPLEX and NEOREZ by Dow Inc., Midland, MI. Other useful binder materials include fluorinated thermoplastics, optionally in the form of an aqueous emulsion, such as those sold under the trade designation THV by 3M Company, St. Paul, MN.

The latex can be cast onto the optional scrims and/or the non-woven core layer from an aqueous solution. The latex binder can be present in any suitable amount relative to the solids content of the aqueous solution. The latex binder can be present in an amount of from 1 wt % to 70 wt %, 3 wt % to 50 wt %, 5 wt % to 20 wt %, or in some embodiments, less than, equal to, or greater than 1 wt %, 2, 3, 4, 5, 7, 10, 12, 15, 17, 20, 25, 30, 35, 40, 45, 50, 55, 60, 65 or 70 wt % based on the overall solids weight of the coating.

The binder can also provide adhesion between the optional scrims and the non-woven core layer. This can be achieved by coating the binder onto inner surfaces of the optional scrim(s) before placing the scrims in contact with the non-woven core layer. Optionally, the binder can be spray coated onto these inner surfaces from solution. The binder could also provide adhesion between the OPAN core layer and the busbar.

The coating should be sufficiently thick to form an edge seal that is generally uniform and void-free when the optional scrims, and the non-woven core layer, are subjected to heat and/or pressure. The minimum coating weight for a given application would depend on the porosity and thickness of the scrims and non-woven core layer, among other factors. In exemplary embodiments, the coating has a basis weight of from 2 gsm to 100 gsm, from 5 gsm to 50 gsm, from 10 gsm to 20 gsm, or in some embodiments, less than, equal to, or greater than 2 gsm, 3, 4, 5, 7, 10, 12, 15, 17, 20, 25, 30, 35, 40, 45, 50, 55, 60, 65, 70, 75, 80, 85, 90, 95, or 100 gsm.

It can be advantageous for the coating to contain other components in addition to the binder. For example, where the binder is not flame-resistant, the coating can further include a flame retardant additive.

Flame tests conducted on these articles used to measure compliance with the UL94-V0 flammability standard revealed that thin sections in the non-woven core layer are most vulnerable to burning. Further, edge sealing of the non-woven core layer results in areas of reduced thickness and was also discovered to reduce the degree of expansion when subjected to very high temperatures (e.g., exceeding 500° C.). As a result, the addition of a flame retardant into the coating applied to edge sealed areas was found to have an especially significant effect in enhancing overall fire resistance. In certain embodiments, this modification enables the non-woven core layer to pass the UL94-V0 flammability standard. Surprisingly, it was discovered that, in some embodiments, the multilayer non-woven core layer as a whole can pass the UL94-V0 flammability standard, even when the non-woven core layer and the scrims individually cannot.

Useful flame retardant additives include phosphate-based additives, such as ammonium polyphosphate. Ammonium polyphosphate is an inorganic salt of polyphosphoric acid and ammonia, and may be either a linear or branched polymer. Its chemical formula is [NH₄PO₃]ₙ(OH)₂, where each monomer consists of an orthophosphate radical of a phosphorus atom with three oxygens and one negative charge neutralized by an ammonium cation leaving two bonds free to polymerize. In the branched cases some monomers are missing the ammonium anion and instead link to other monomers. Organophosphates other than ammonium polyphosphate can also be used.

Other additives that can enhance fire resistance of the coating include intumescents, or substances that swell as a result of heat exposure. In the provided non-woven core layers, an intumescent additive can include one or more of: (1) a phosphorus-containing part, provided for example by ammonium polyphosphate, (2) a hydroxyl-containing part that increases char in the event of a fire, such as sucrose, catechol, pentaerythritol (“PER”), and gallic acid, and (3) a nitrogen-containing part that can act as blowing agent, such as melamine or ammonium. In a preferred embodiment, components (1)-(3) are all used in combination. Intumescents can also include graphite filler, such as expandable graphite. Expandable graphite is a synthesized intercalation compound of graphite that expands when heated, and thus can act as an intumescent.

The flame retardant additive can be dissolved or dispersed with the binder in a common solvent and both components solution cast onto the scrims and/or the non-woven core layer. Conveniently, ammonium polyphosphate can be cast from an aqueous solution that also contains a polymer latex.

The flame retardant additive can be present in an amount of from 5 wt % to 95 wt %, from 10 wt % to 90 wt %, from 20 wt % to 60 wt %, or in some embodiments, less than, equal to, or greater than 5 wt % 10, 15, 20, 25, 30, 35, 40, 45, 50, 55, 60, 65, 70, 75, 80, 85, 90, or 95 wt % based on the overall solids weight of the coating.

The aqueous solution itself can have any suitable concentration to provide an appropriate viscosity for the selected coating method, and provide for a uniform coating on the fibers of the scrims and/or the non-woven core layer. For spray coating, it is typical to use a solids content of from 1 wt % to 50 wt %, from 2.5 wt % to 25 wt %, from 5 wt % to 15 wt %, or in some embodiments, less than, equal to, or greater than 1 wt %, 1.5, 2, 2.5, 3, 3.5, 4, 4.5, 5, 6, 7, 8, 9, 10, 12, 15, 17, 20, 25, 30, 35, 40, 45, or 50 wt %.

### Scrims

While not required, one or more scrims can be disposed on the non-woven core layer. The scrims need not be particularly restricted, and can include any type of open mesh structure that is either woven or non-woven. Scrims can provide the non-woven core layer with additional strength and stiffness, if desired.

Woven scrims may have any type of weave, and non-woven scrims are produced using any well-known technique, including melt blowing, spun lace and spun bond techniques.

Non-woven scrims include those made from any of a broad variety of fibers including polyethylene fibers, polypropylene fibers, mixtures of polyethylene and polypropylene fibers, nylon fibers (such as the nylons described above), polyester fibers (such as the polyesters described above), acrylic and modacrylic fibers such as polyacrylonitrile fibers and acrylonitrile and vinyl chloride copolymer fibers, polystyrene fibers, polyvinyl acetate fibers, polyvinylchloride fibers, cellulose acetate fibers, glass fibers and viscose fibers. In addition to the above synthetic fibers there may also be used the natural fibers such as cotton or wool.

In the provided non-woven core layers, suitable polymeric fibers used to produce the scrim include polyamides, polyesters and polyolefins, particularly polyethylene and polypropylene, or a combination thereof. The scrim may also contain fiberglass. In some embodiments, the open mesh fabric comprises at least one nylon, a high-density polyethylene or a combination thereof.

In various embodiments, each of the scrims is composed of flame-resistant fibers. While fiberglass fibers have better intrinsic fire resistance than the aforementioned polymers, even combustible polymers can be provided with significant fire resistance by blending with sufficient amounts of a flame retardant additive. For example, these scrims can be made from polyester fibers that display some degree of flame-resistance.

The flame retardant additive can be either miscible or immiscible with the host polymer. Miscible additives include polymer melt additives such as phosphorus-based flame retardants that contain phenolic end groups. Polyphosphonates, including polyphosphonate homopolymers and copolymers, can also be miscibly blended with polyesters to form flame-resistant fibers. Useful additives are commercially available under the trade designation NOFIA from FRX Polymers, Inc., Chelmsford, MA. Generally, miscible additives are preferred in making scrims with fine fiber diameters. If fiber diameters are larger than 10 micrometers, then inclusion of certain immiscible salts could also be used to enhance fire resistance.

Flame-resistant fibers can be, in some embodiments, capable of passing the UL94-V0 flammability standard when formed into a non-woven web made from 100% of such fibers, and having a basis weight of less than 250 gsm and web thickness of less than 6 millimeters.

Suitable scrims need not be fibrous. Scrims can, for example, include continuous films that are perforated to form a mesh-like structure. Useful scrims can be made from a perforated film, such as described in U.S. Pat. No. 6,617,002 (Wood), U.S. Pat. No. 6,977,109 (Wood), and U.S. Pat. No. 7,731,878 (Wood).

The scrims are generally much thinner than the non-woven core layer. To minimize the weight of the non-woven core layer, the scrims can be made only as thick as necessary to serve the purpose of encapsulating loose fibers in the non-woven core layer while satisfying any technical requirements for strength and toughness. In a preferred embodiment, one or both scrims have a basis weight of from 10 gsm to 100 gsm, from 20 gsm to 80 gsm, from 30 gsm to 70 gsm, or in some embodiments, less than, equal to, or greater than 10 gsm, 12, 15, 17, 20, 25, 30, 35, 40, 45, 50, 55, 60, 65, 70, 75, 80, 85, 90, 95, or 100 gsm.

Further variants are possible. For example, the fibers in the non-woven core layer and/or scrim can be coated with other compositions that are not binders. The coating on the fibers can be selected from, for example, silicones, acrylates, and fluoropolymers whereby the non-woven core layer has an emissivity of less than 0.5. Here, “emissivity” is defined as the ratio of the energy radiated from a material's surface to that radiated from a blackbody (a perfect emitter) at the same temperature and wavelength and under the same viewing conditions. Reducing emissivity helps lower the extent to which a material loses heat from thermal radiation. A particular useful silicone coating is based on an aqueous silicone dispersion, which can penetrate into the fibers of the non-woven and coat fiber surfaces that are remote from the surface of the layer.

Coating the constituent fibers of the non-woven core layer can impart significant functional and/or aesthetic benefits. For example, coating the fibers has the effect of reinforcing the fibers, thus increasing the overall strength of the web. This reinforcement effect can even survive exposure to extreme temperatures, such as when burned. As mentioned earlier regarding the barrier layer 105′ in FIG. 1B, a significant and unexpected benefit of using silicone-based coatings is the ability for these coatings to survive combustion as a silicon dioxide shell even when the core of the fiber is burned away or otherwise eroded. These oxide shells provide mechanical integrity, which can be critical in preserving the electrically-insulative function of the core layer.

Certain coating materials, such as fluoropolymers and silicones, may enhance resistance to staining or fouling because of airborne substances becoming adhered to fiber surfaces. In some applications it can be desirable to sheath the fibers in an opaque coating, can also be used to change the color of the non-woven core layer, which would be generally be black or grey for OPAN fibers or other carbonized fibers.

The non-woven core layers can have any suitable thickness based on the space allocated for a given application. The non-woven core layers can have a thickness of from 0.5 millimeter to 50 millimeters, from 2 millimeters to 25 millimeters, from 3 millimeters to 20 millimeters, or in some embodiments, less than, equal to, or greater than 0.1 millimeters, 0.2. 0.3, 0.4, 0.5, 0.6, 0.7, 0.8, 0.9, 1, 1.1, 1.2, 1.5, 2, 3, 4, 5, 6, 7, 8, 9, 10, 12, 15, 17, 20, 22, 25, 27, 30, 35, 40, 45, or 50 millimeters.

The provided non-woven core layers can be made in a variety of ways, including batch methods and continuous methods.

In an exemplary manufacturing process, bulk fibers of the non-woven core layer, such as OPAN fibers, are initially fed into a carding process. These fibers can be blended with optional reinforcing fibers and/or binder fibers, such as a high temperature polyester fiber. In an exemplary process, OPAN fibers are blended with a high temperature polyethylene terephthalate staple fiber and carded to form a non-woven core layer having a thickness of about 8 mm.

The top and bottom major surfaces of the web are then spray coated with a binder solution. Dispersed in the solution is a polymeric binder and optionally a soluble flame retardant additive to improve the fire resistance of the coating. Based on environmental, health, and safety factors, it can be advantageous to use an aqueous binder solution, and avoid the need for volatile organic solvents. In alternative embodiments, the spray coating is applied only to the top or only to the bottom major surface of the web.

The spray coating step can result in the binder solution penetrating deeply into the non-woven core layer, depending on the spraying technique, size of the spray droplets and thickness of the layer. In some embodiments, the depth of penetration is 100%, or greater than, equal to, or less than 95%, 90, 85, 80, 75, 70, 65, 60, 55, or 50%, relative to the thickness of the non-woven core layer.

Edge sealing can be achieved using any number of useful methods. One method involves direct application of heat and pressure simultaneously by placing the open-edged non-woven core layer in contact with a tool having one or more heated surfaces. In some embodiments, the surfaces are metal tool surfaces.

Instead of using a heated tool, it is possible to heat one or both major surfaces of the open-edged non-woven core layer immediately prior to pressing it between unheated tool surfaces to edge seal the non-woven core layer. Heat can be imparted by heated air (e.g., by convective heating) or by exposure to light (e.g., radiative heating). In some embodiments, the scrim surfaces are joined together using ultrasonic welding. Advantageously, heat or ultrasonic welding can be performed along a narrow linear section of the non-woven core layer to facilitate its bending along a corresponding bent section of the underlying busbar or housing component. Ultrasonic welding can also be used to bond the non-woven core layer to plastic or composite battery components, or to facilitate wrapping of the non-woven core layer around a busbar or other electrically-conductive battery component.

After edge sealing, it is generally desirable for the sealed non-woven core layer to be cleanly removable from the tool surfaces. Clean removal can be facilitated by judicious selection of the binder. To avoid sticking issues, it is preferred that the softening temperature (e.g., T_{g}) of the binder is well below the softening point of the scrim. If the scrim is made from a semi-crystalline polymer such as a polyester, this softening temperature can correspond to its melting temperature. Using an edge seal temperature well below the melting temperature of the scrim also helps avoid inducement of brittleness in the scrim that can result from melting and re-crystallization in the fiber polymer.

Further options and advantages associated with edge sealing these layered constructions can be found in PCT Patent Publication No. WO 2020/019114 (Wu, et al.).

### EXAMPLES

Objects and advantages of this disclosure are further illustrated by the following non-limiting examples, but the particular materials and amounts thereof recited in these examples, as well as other conditions and details, should not be construed to unduly limit this disclosure. Unless otherwise noted, all parts, percentages, ratios, etc. in the Examples and the rest of the specification are by weight.

TABLE 1
Materials

| Designation | Description | Source |
|---|---|---|
| AP462 | Ammonium polyphosphate, | Clariant AG, Muttenz, |
| | microencapsulated with melamine | Switzerland |
| | resin available under the trade | |
| | designation EXOLIT ® AP462 | |
| D1171 | Polydimethylsiloxane emulsion | Dow Chemical Company, |
| | available under the trade designation | Midland, MI, United |
| | Dow Corning 2-1171 Emulsion | States |
| D1181 | Silicone emulsion coating available | Dow Chemical Company |
| | under the trade designation “SYL- | |
| | OFF” 1181 | |
| EM1171A | Silicone emulsion coating available | Dow Chemical Company |
| | under the trade designation “SYL- | |
| | OFF” EM-1171A | |
| FRC490 | Phosphorous-based flame retardant | Budenheim USA, Inc., |
| | available under the trade designation | Mansfield, OH, United |
| | FR CROS ® 490 | States |
| GULFENG | A flame-retardant non-woven blended | Toray Industries, Inc., |
| | fabric available under the trade | Tokyo, Japan |
| | designation “GULFENG” | |
| HP-A | Halloysite natural clay available under | Applied Minerals Inc., |
| | the trade designation DRAGONITE- | Brooklyn, NY, United |
| | HP-A | States |
| M200 | Muscovite mica available under the | CB Minerals, |
| | trade designation SE MICA 200 | Mamaroneck, NY, United |
| | | States |
| OPAN1 | High-density (1.4 g/cm³) oxidized | ZOLTEK Corporation |
| | polyacrylonitrile staple fibers, 1.7 | (wholly owned subsidiary |
| | dTex and 50 mm cut length available | of Toray Group), |
| | under the trade designation “OX” | Bridgeton, MO, United |
| | | States |
| OPAN2 | Standard density (1.37 g/cm³) | ZOLTEK Corporation |
| | oxidized polyacrylonitrile staple | (wholly owned subsidiary |
| | fibers, 5.0 dTex and 50 mm cut length | of Toray Group) |
| | available under the trade designation | |
| | “OX” | |
| PX90 | Non-woven blended fabric available | Fibertex Nonwovens A/S, |
| | under the trade designation PX90 | Aalborg, Denmark |
| V460 | Anionic stabilized vinyl chloride- | Lubrizol Corporation, |
| | acrylic copolymer emulsion available | Wickliffe, OH, United |
| | under the trade designation VYCAR | States |
| | 460 × 46 | |
| VERM | Vermiculite: 0.3 to 0.8 mm particle | Cometals, Inc, New York, |
| | size | NY, United States |
| PI Film | 25 micrometer thick polyimide film | Dupont, Wilmington, DE, |
| | available under the trade designation | United States |
| | Kapton ® B | |

### Test Methods

### Thickness Measurement

The method of ASTM D5736-95 was followed, according to test method for thickness of high loft non-woven fabrics. The plate pressure was calibrated at 0.002 psi (13.790 Pascal).

### Dielectric Strength Test:

The methods of IEC 60243-1 were followed. 11 cm×11 cm samples were manually applied to e-coated 15 cm×20 cm steel sheets obtained from DEFTA Group of Madrid, Spain. Samples were bonded to the steel sheets with adhesive with a two-kilogram pressure roller. The samples were subjected to 1000 volts at ambient temperature and after exposure to 500° C. in a THERMOLYNE 1200° C. muffle furnace (obtained from Thermo Fisher Scientific of Waltham, MA. United States) for five minutes. Dielectric strength breakdown (kV) values were recorded. Three samples were tested, and an average value was recorded.

### UL94-V0 Flame Test:

Referenced the UL94-V0 standard with flame height of 20 millimeters (mm), the bottom edge of the sample was placed 10 mm into the flame and twice burned at 10 seconds each. A flame propagation height under 125 mm (5 inches) was considered a pass.

### Abrasion Resistant Test:

9 cm×2 cm samples were positioned on the base of a crockmeter and secured with clamps. A reciprocating arm of the crockmeter held a 2×2 cm plastic component applied a cyclical constant force at a speed of 147 RPM (2.24 cycles per second) at 0.8 N for 150,000 cycles (17 hours). The test was conducted at 23° C.±2° C. at 50%±5% relative humidity. The number of cycles that the sample survived before visually displaying an abraded surface was recorded.

### Hot-Side/Cold-Side Test

In an MTS Insight 50 kN tensile test machine (obtained from MTS Insight of Eden Prairie, MN, United States), a bottom platen was heated to 600° C., and a 11 cm×11 cm sample attached to either an e-coated 15 cm×20 cm steel or ceramic sheet was placed on top of it. The upper platen, with a thermocouple embedded, was lowered until the compression pressure reached 1 MPa. The temperature increase at the cold-side was recorded with respect to time (continuously) until it reached 600 seconds (10 minutes). Temperature and compression results were reported on performance of the samples at ten second intervals.

### Compression Test

In an MTS Insight 50 kN tensile test machine (obtained from MTS Insight of Eden Prairie, MN, United States). First without samples inside, the load cell was closed to set the gap to 0 mm. The load cell was then opened to over 10 mm to insert 50.8 mm×50.8 mm square samples. The load cell force was set to 0. Then, the load cell was gradually closed at a speed of 1 mm per minute. The compression force was recorded. The sample free standing thickness was set when the compression force reached 10 Newtons.

Non-woven webs produced in the following examples were produced by processes and techniques described in the commonly owned PCT Patent Publication No. WO 2015/080913 (Zillig et al) unless otherwise stated. Fabrics (i.e., samples) were produced by processing the non-woven webs with binder solutions.

### Comparative Example 1 (CE1)

PX90 samples underwent Dielectric Strength, UL94-V0 and Abrasion Resistant Testing. Results are represented in Table 2.

### Comparative Example 2 (CE2)

GULFENG samples underwent Dielectric Strength, UL94-V0 and Abrasion Resistant Testing. Results are represented in Table 2.

### Comparative Example 3 (CE3)

A 100 wt. % OPAN1 web was produced. The web was folded upon itself (changing basis weight to 150 gsm) and was then conveyed by a Dilo Needle Loom, Model DI-Loom OD-1 6 from Eberbach, Germany having a needle board array of 23 rows of 75 needles/row where the rows are slightly offset to randomize the pattern. The needles were Foster 20 3-22-1.5B needles. The array was roughly 17.8 cm (7 inches) deep in the machine direction and nominally 61 cm (24 inches) wide with needle spacings of roughly 7.6 mm (0.30 inches). The needle board was operated at 91 strokes/minute to entangle and compact the web to a roughly 5.1-mm (0.20 inch) thickness. The basis weight of the web was 50 gsm±10%. The samples underwent Dielectric Strength, UL94-V0 and Abrasion Resistant Testing. Results are represented in Table 2.

### Comparative Example 4 (CE4)

A 70 wt. % OPAN1 and 30 wt. % OPAN2 blended web was produced. The web was folded upon itself (changing basis weight to 150 gsm) and was then conveyed by a Dilo Needle Loom, Model DI-Loom OD-1 6 from Eberbach, Germany having a needle board array of 23 rows of 75 needles/row where the rows are slightly offset to randomize the pattern. The needles were Foster 20 3-22-1.5B needles. The array was roughly 17.8 cm (7 inches) deep in the machine direction and nominally 61 cm (24 inches) wide with needle spacings of roughly 7.6 mm (0.30 inches). The needle board was operated at 91 strokes/minute to entangle and compact the web to a roughly 5.1-mm (0.20 inch) thickness. The basis weight of the web was 100 gsm±10%. The samples underwent Dielectric Strength, UL94-V0 and Abrasion Resistant Testing. Results are represented in Table 2.

### Example 1 (EX1)

Sample webs were produced as described in Comparative Example 3 (CE3). A 20 gsm coating solution containing 80 wt. % V460 and 20 wt. % FRC490 was spray coated onto the web. The OPAN web with coating solution at 0.5 mm thickness was uniformly compressed by a hand roller to a 0.5 mm thickness. Samples underwent Dielectric Strength, UL94-V0 and Abrasion Resistant Testing. Results are represented in Table 2.

### Example 2 (EX2)

Sample webs were produced as described in Comparative Example 4 (CE4). A 40 gsm coating solution containing 80 wt. % V460 and 20 wt. % FRC490 was spray coated onto the web. The OPAN web with coating solution at 1.0 mm thickness was uniformly compressed by a hand roller to a 0.5 mm thickness. Samples underwent Dielectric Strength, UL94-V0 and Abrasion Resistant Testing. Results are represented in Table 2.

### Example 3 (EX3)

Sample webs were produced as described in Comparative Example 3 (CE3). A 100 gsm coating solution containing 100 wt. % 2:1 D1171 and EM1171A silicone dispersion and 100 wt. % FRC490 was spray coated onto the web. The OPAN web with coating solution at 0.5 mm thickness was uniformly compressed by a hand roller to a 0.5 mm thickness. The sample total basis weight was 150 gsm. Samples underwent UL94-V0 Testing. Results are represented in Table 2.

### Example 4 (EX4)

Sample webs were produced as described in Comparative Example 4 (CE4). A 150 gsm coating solution containing 100 wt. % 2:1 D1171 and EM1171A silicone dispersion and 100 wt. % FRC490 was spray coated onto the web. The OPAN web with coating solution at 1 mm thickness was uniformly compressed by a hand roller to a 1 mm thickness. The final web basis weight was 250 gsm. The sample underwent Hot-Side/Cold-Side and Compression Testing. Results are represented in Table 2.

### Example 5 (EX5)

Sample webs were produced as described in Comparative Example 4 (CE4). A 20 gsm coating solution containing 80 wt. % 2:1 D1171 and EM1171A silicone dispersion and 20 wt. % FRC490 was spray coated onto the web. The samples were hung for 24 hours inside a hood to dry and then cured at 200° C. for five minutes.

### Example 6 (EX6)

Sample webs were produced as described in Comparative Example 4 (CE4). A 150 gsm coating solution containing 100 wt. % 2:1 D1171 and EM1171A silicone dispersion and 100 wt. % FRC490 and 20 wt. % M200 was spray coated onto the web. The OPAN web with coating solution at 1 mm thickness was uniformly compressed by a hand roller to a 1 mm thickness. After drying, the sample was then cured at 200° C. for five minutes.

### Example 7 (EX7)

Sample webs were produced as described in Comparative Example 4 (CE4). A 200 gsm coating solution containing 100 wt. % 2:1 D1171 and EM1171A silicone dispersion and 100 wt. % FRC490 and 30 wt. % VERM was spray coated onto the web. The OPAN web with coating solution at 1 mm thickness was uniformly compressed to spread out the VERM uniformly on top of the OPAN web. The samples were then hung for 24 hours inside a hood to dry and then cured at 200° C. for five minutes.

### Example 8 (EX8)

Sample webs were produced as described in Comparative Example 4 (CE4). Sample were immersed in a coating solution containing 10 wt. % of V460 (diluted with water 90%) and uniformly compressed to spread out the coating on top. Samples were stored at room temperature for two hours and then cured at 160° C. for 40 minutes resulting in a basis weight of 147 gsm for the coating (247 gsm total). Samples underwent Dielectric Strength, UL94-V0 and Abrasion Resistant Testing. Results are represented in Table 2.

### Example 9 (EX9)

Sample webs were produced as described in Comparative Example 4 (CE4). A coating solution containing 14.0 wt. % D1181 and 0.7 wt. % of EM1171A and 85.3 wt. % water was mixed with 5.0 wt. % HP-A. The coating formulation was spray coated onto the samples. The samples were hung for two hours inside a hood to dry and then cured at 80° C. for 20 minutes. They were then cured at high temperature (175° C.) for 40 minutes resulting in basis weight of a 55 gsm for the coating (155 gsm total). Samples underwent UL94-V0, Dielectric strength, and Abrasion Resistant Testing. Results are represented in Table 2.

### Example 10 (EX10)

Sample webs were produced as described in Comparative Example 4 (CE4). A coating solution containing 14.0 wt. % D1181 and 0.7 wt. % of EM1171A and 85.3 wt. % water was mixed with 5.0 wt. % HP-A. The coating formulation was spray coated onto the samples. The coating solution covered the samples by immersion. The samples were compressed by a hand roller to a 1 mm thickness. The samples were hung for two hours inside a hood to dry and then cured at 80° C. for 10 minutes. They were then cured at high temperature (175° C.) for 40 minutes resulting in a basis weight of 119 gsm for the coating (219 gsm total). Samples underwent UL94-V0, Dielectric strength, and Abrasion Resistant Testing. Results are represented in Table 2.

### Example 11 (EX11)

Sample webs were produced as described in Comparative Example 4 (CE4). A coating solution containing 14.0 wt. % D1181 and 0.7 wt. % of EM1171A and 85.3 wt. % water was mixed with 15.0 wt. % HP-A. The coating formulation was spray coated onto the samples. The samples were hung for two hours inside a hood to dry and then cured at 80° C. for 20 minutes. They were then cured at high temperature (175° C.) for 40 minutes resulting in a 77 gsm coating (177 gsm total). Samples underwent UL94-V0, Dielectric strength, and Abrasion Resistant Testing. Results are represented in Table 2.

### Example 12 (EX12)

Sample webs were produced as described in Example 4. The samples were then spray coated with Super 77 spray adhesive (obtained from 3M Company of St. Paul, MN. United States) and laminated to PI Film on both sides. The sample underwent Hot-Side/Cold-Side and Compression Testing. Results are represented in Tables 3 and 4.

TABLE 2
Dielectric, UL94V0, and Abrasion Test Results

| | Dielectric | Dielectric | | |
|---|---|---|---|---|
| | Strength - | Strength - | | Abrasion |
| | Before 500° C. | After 500° C. | | Resistance |
| | (kV) | (kV) | UL94-V0 | (Cycles) |
| CE1 | 2.15 | 2.30 | Fail | 10000 |
| CE2 | 1.25 | 1.40 | Fail | 8000 |
| CE3 | 1.30 | 0.97 | Pass | 4000 |
| CE4 | 2.10 | 1.67 | Pass | 8600 |
| EX1 | 2.13 | 0.93 | Pass | 110000 |
| EX2 | 1.80 | 1.17 | Pass | 100000 |
| EX3 | DNT | DNT | Fail | DNT |
| EX8 | 1.87 | 1.07 | Pass | 100000 |
| EX9 | 2.13 | 2.07 | Pass | 100000 |
| EX10 | 3.27 | 2.23 | Pass | 110000 |
| EX11 | 2.20 | 2.07 | Pass | 100000 |
| EX12 | DNT | DNT | DNT | DNT |

DNT: Did not Test

TABLE 3
Hot-Side/Cold-Side Test Results

| | | EX4 | | EX12 | |
|---|---|---|---|---|---|
| Time | Hot-Side | Cold-Side | Load | Cold-Side | Load |
| (sec) | Temp (° C.) | Temp (° C.) | (kN) | Temp (° C.) | (kN) |
| 0.109 | 598.000 | 25.000 | 0.004 | 30.000 | 0.003 |
| 10.009 | 573.000 | 103.000 | 4.263 | 72.000 | 4.254 |
| 20.024 | 550.000 | 163.000 | 4.262 | 129.000 | 4.246 |
| 30.024 | 549.000 | 195.000 | 4.256 | 159.000 | 4.254 |
| 40.024 | 553.000 | 225.000 | 4.266 | 189.000 | 4.251 |
| 50.024 | 557.000 | 249.000 | 4.266 | 215.000 | 4.251 |
| 60.024 | 563.000 | 274.000 | 4.265 | 237.000 | 4.254 |
| 70.024 | 567.000 | 297.000 | 4.267 | 259.000 | 4.248 |
| 80.024 | 572.000 | 318.000 | 4.266 | 275.000 | 4.254 |
| 90.024 | 576.000 | 342.000 | 4.261 | 292.000 | 4.247 |
| 100.024 | 579.000 | 363.000 | 4.265 | 308.000 | 4.251 |
| 110.024 | 583.000 | 385.000 | 4.259 | 322.000 | 4.248 |
| 120.024 | 589.000 | 403.000 | 4.264 | 337.000 | 4.250 |
| 130.024 | 594.000 | 418.000 | 4.265 | 349.000 | 4.247 |
| 140.024 | 596.000 | 432.000 | 4.262 | 362.000 | 4.246 |
| 150.024 | 598.000 | 443.000 | 4.264 | 373.000 | 4.248 |
| 160.024 | 598.000 | 455.000 | 4.266 | 385.000 | 4.249 |
| 170.024 | 599.000 | 465.000 | 4.260 | 396.000 | 4.254 |
| 180.024 | 599.000 | 473.000 | 4.259 | 405.000 | 4.248 |
| 190.024 | 600.000 | 481.000 | 4.265 | 414.000 | 4.254 |
| 200.024 | 600.000 | 488.000 | 4.264 | 422.000 | 4.248 |
| 210.024 | 600.000 | 495.000 | 4.260 | 430.000 | 4.247 |
| 220.024 | 601.000 | 501.000 | 4.263 | 438.000 | 4.253 |
| 230.024 | 601.000 | 506.000 | 4.263 | 444.000 | 4.249 |
| 240.024 | 601.000 | 511.000 | 4.262 | 450.000 | 4.253 |
| 250.024 | 601.000 | 515.000 | 4.265 | 455.000 | 4.252 |
| 260.024 | 601.000 | 519.000 | 4.259 | 460.000 | 4.253 |
| 270.024 | 601.000 | 523.000 | 4.263 | 465.000 | 4.246 |
| 280.024 | 601.000 | 525.000 | 4.264 | 468.000 | 4.247 |
| 290.024 | 601.000 | 528.000 | 4.263 | 472.000 | 4.246 |
| 300.024 | 601.000 | 530.000 | 4.265 | 476.000 | 4.253 |
| 310.024 | 601.000 | 533.000 | 4.263 | 479.000 | 4.250 |
| 320.024 | 601.000 | 534.000 | 4.267 | 482.000 | 4.247 |
| 330.024 | 601.000 | 536.000 | 4.267 | 485.000 | 4.252 |
| 340.024 | 601.000 | 538.000 | 4.260 | 487.000 | 4.246 |
| 350.024 | 601.000 | 539.000 | 4.267 | 489.000 | 4.245 |
| 360.024 | 601.000 | 540.000 | 4.264 | 492.000 | 4.252 |
| 370.024 | 601.000 | 541.000 | 4.264 | 494.000 | 4.250 |
| 380.024 | 601.000 | 542.000 | 4.261 | 495.000 | 4.248 |
| 390.024 | 601.000 | 543.000 | 4.259 | 497.000 | 4.249 |
| 400.024 | 601.000 | 543.000 | 4.266 | 498.000 | 4.252 |
| 410.024 | 601.000 | 544.000 | 4.265 | 499.000 | 4.250 |
| 420.024 | 600.000 | 544.000 | 4.260 | 501.000 | 4.252 |
| 430.024 | 601.000 | 545.000 | 4.261 | 502.000 | 4.252 |
| 440.024 | 600.000 | 546.000 | 4.259 | 503.000 | 4.248 |
| 450.024 | 600.000 | 546.000 | 4.261 | 503.000 | 4.248 |
| 460.024 | 600.000 | 547.000 | 4.262 | 504.000 | 4.249 |
| 470.024 | 600.000 | 547.000 | 4.264 | 505.000 | 4.248 |
| 480.024 | 600.000 | 547.000 | 4.266 | 506.000 | 4.246 |
| 490.024 | 600.000 | 547.000 | 4.260 | 506.000 | 4.248 |
| 500.024 | 600.000 | 548.000 | 4.264 | 507.000 | 4.252 |
| 510.024 | 600.000 | 548.000 | 4.261 | 507.000 | 4.250 |
| 520.024 | 600.000 | 548.000 | 4.260 | 508.000 | 4.247 |
| 530.024 | 600.000 | 548.000 | 4.265 | 508.000 | 4.247 |
| 540.024 | 600.000 | 549.000 | 4.259 | 508.000 | 4.249 |
| 550.024 | 600.000 | 549.000 | 4.265 | 509.000 | 4.247 |
| 560.024 | 600.000 | 549.000 | 4.259 | 509.000 | 4.251 |
| 570.024 | 600.000 | 549.000 | 4.261 | 509.000 | 4.254 |
| 580.024 | 600.000 | 549.000 | 4.265 | 509.000 | 4.250 |
| 590.024 | 600.000 | 549.000 | 4.260 | 510.000 | 4.246 |
| 600.024 | 600.000 | 549.000 | 4.265 | 510.000 | 4.248 |

TABLE 4
Compression Test Results

| | |
|---|---|
| EX4 | EX12 |

| Gap | Compression | Gap | Compression |
|---|---|---|---|
| (mm) | (Pa) | (mm) | (Pa) |
| 2.37 | 399.33 | 2.14 | 1248.76 |
| 2.29 | 377.53 | 2.05 | 1671.95 |
| 2.21 | 584.11 | 1.97 | 2143.41 |
| 2.12 | 680.50 | 1.89 | 3726.02 |
| 2.04 | 856.82 | 1.83 | 4503.25 |
| 1.96 | 1101.01 | 1.83 | 4280.74 |
| 1.87 | 1326.79 | 1.83 | 4323.64 |
| 1.79 | 1704.71 | 1.83 | 4212.87 |
| 1.71 | 2673.59 | 1.82 | 4936.49 |
| 1.60 | 4144.64 | 1.78 | 5930.12 |
| 1.50 | 7825.55 | 1.63 | 14036.31 |
| 1.40 | 14667.13 | 1.53 | 23226.98 |
| 1.30 | 26426.36 | 1.43 | 35127.86 |
| 1.20 | 45414.74 | 1.33 | 50538.81 |
| 1.00 | 110749.80 | 1.13 | 107715.90 |
| 0.90 | 148043.30 | 1.03 | 149827.70 |
| 0.80 | 188341.80 | 0.93 | 197524.80 |
| 0.70 | 239129.20 | 0.83 | 260660.00 |
| 0.60 | 313634.10 | 0.73 | 365049.70 |
| 0.50 | 427784.20 | 0.62 | 467299.60 |

All cited references, patents, and patent applications in the above application for letters patent are herein incorporated by reference in their entirety in a consistent manner. In the event of inconsistencies or contradictions between portions of the incorporated references and this application, the information in the preceding description shall control. The preceding description, given in order to enable one of ordinary skill in the art to practice the claimed disclosure, is not to be construed as limiting the scope of the disclosure, which is defined by the claims and all equivalents thereto.

What is claimed is:

1. A battery assembly comprising:
a housing;
one or more battery cells electrically coupled to a busbar, the one or more battery cells and the busbar being received in the housing; and
a fibrous core layer disposed between the busbar and the housing,
wherein the fibrous core layer comprises a plurality of oxidized polyacrylonitrile fibers and a coating disposed thereon that binds the plurality of oxidized polyacrylonitrile fibers to each other.

2. The battery assembly of claim 1, wherein the fibrous core layer is a non-woven core layer.

3. The battery assembly of claim 1, wherein the coating is a continuous coating.

4. The battery assembly of claim 1, wherein the coating comprises a silicone.

5. The battery assembly of claim 1, wherein the coating comprising a vinyl acrylate.

6. The battery assembly of claim 5, wherein the vinyl acrylate is a polyvinylchloride acrylate.

7. The battery assembly of claim 4, wherein the coating further comprises a polyphosphate dispersed in the silicone or vinyl acrylate.

8. The battery assembly of claim 7, wherein the polyphosphate comprises ammonium polyphosphate, and optionally wherein the ammonium polyphosphate is present as particles encapsulated by melamine.

9. The battery assembly of claim 8, wherein the polyphosphate is present in an amount of from 5 percent to 80 percent by weight relative to the overall weight of the coating.

10. The battery assembly of claim 1, wherein the coating has a basis weight of from 2 gsm to 500 gsm.

11. The battery assembly of claim 1, wherein the plurality of oxidized polyacrylonitrile fibers are substantially entangled along directions perpendicular to a major surface of the fibrous core layer.

12. The battery assembly of claim 1, wherein the plurality of oxidized polyacrylonitrile fibers represent over 80 vol % of fibers in the fibrous core layer.

13. A battery assembly comprising:
an housing;
one or more battery cells electrically coupled to a busbar, the one or more battery cells and the busbar being received in the housing; and
a fibrous core layer disposed between the busbar and the housing, wherein the fibrous core layer comprises a plurality of oxidized polyacrylonitrile fibers; and
a continuous barrier layer extending across one or both major surfaces of the core layer.

14. The battery assembly of claim 13, wherein the continuous barrier layer comprises a polyimide

15. The battery assembly of claim 13, wherein the continuous barrier layer comprises an inorganic filler dispersed in a binder.

16. The battery assembly of claim 15, wherein the inorganic filler comprises halloysite, vermiculite, mica, or a combination thereof.

17. The battery assembly of claim 15, wherein the inorganic filler is localized at a surface of the non-woven core layer.

18. The battery assembly of claim 15, wherein the binder comprises a silicone.

19. The battery assembly of claim 1, wherein the fibrous core layer further comprises a plurality of reinforcing fibers that are different from the plurality of oxidized polyacrylonitrile fibers, the reinforcing fibers differing from the plurality of oxidized polyacrylonitrile fibers in composition, fiber diameter, and/or degree of oxidation.

20. A method of electrically insulating a battery housing from a busbar within a battery assembly, the method comprising:
disposing a fibrous core layer on either the busbar or at least a portion of the battery housing; and
bringing together the battery housing and the busbar whereby the fibrous core layer is disposed therebetween,
wherein the fibrous core layer comprises a plurality of oxidized polyacrylonitrile fibers and a coating disposed thereon that binds the plurality of oxidized polyacrylonitrile fibers to each other.
